(19) United States
(12) Patent Application Publication
(10) Pub. No.: US 2019/0309873 A1
(43) Pub. Date: Oct. 10, 2019

(54) ACTUATED VALVE MECHANISM FOR FLUID FLOW CONTROL

(71) Applicant: TOMAR WATER SYSTEMS, INC., San Marcos, CA (US)

(72) Inventors: Adam ROBBINS, San Marcos, CA (US); Christopher Veit, San Marcos, CA (US)

(73) Assignee: TOMAR WATER SYSTEMS, INC., San Marcos, CA (US)

(21) Appl. No.: 15/947,668

(22) Filed: Apr. 6, 2018

(51) Int. Cl. F16K 31/04; F16K 31/53; G05D 7/01

(52) U.S. Cl. CPC F16K 31/04; G05D 7/0113; F16K 31/535

(57) ABSTRACT

A motorized metering valve actuation mechanism having a drive motor with a drive motor spur gear and a metering valve an idler spur gear. In operation, the drive motor turns the drive motor spur gear which turns the idler spur gear to adjust flow through the metering valve. The idle spur gear moves up and down along the face of the drive motor spur gear as the metering valve is opened or closed.

### FIELD OF THE INVENTION

The invention relates to a mechanism which provides the ability to precisely control fluid flow through a metering valve by means of signals received from an electronic controller. More particularly, the invention relates to a unique combination of metering valve, drive motor, gear train between valve and motor, position sensing device(s) and electronic circuits that together function to allow precise and remotely controlled fluid flow control in a variety of applications notably in the area of membrane separation systems where precise and automatically variable control of fluid flows would be of great value.

### BACKGROUND OF THE INVENTION

A membrane separation system is a hydraulic system that operates on a liquid medium, typically water, with the purpose of separating certain mineral and chemical solutes in the fluid feed supply into two output streams. Non-limiting examples of membrane separation systems includes nano-filtration, micro-filtration, and reverse osmosis filtration. Non-limiting applications of membrane separation systems may include industrial, agricultural, commercial, and household uses. The two output streams being (i) a purified stream with a great part of the solute components removed; and (ii) a reject or brine stream with the component solutes highly concentrated. The membrane separation system functions on the basis of establishing a significant fluid pressure difference from the input or feed side of a membrane barrier to the other side of the membrane barrier, usually called the product side. The pressure difference motivates the flow of liquid through the semipermeable membrane barrier, which is effective to prevent the simultaneous passage of many salt and mineral solutes through the same membrane barrier, and provides a desired rate of product flow. The successful function of a given membrane system is directly dependent on the liquid pressure applied to the membrane at the feed input, on the rate of flow of the brine or concentrate stream and, in many commercial and larger scale membrane systems, on the rate of a portion of the concentrate stream which is diverted to be mixed with the input feed stream and is referred to as recirculation flow. In most commercial and large scale membrane system designs these three performance elements: (1) membrane feed pressure, (2) concentrate flow and (3) recirculation flow will have specific optimum values which must be maintained within a relatively small tolerance if the membrane system is to operate consistently and satisfactorily over extended time periods. Technology advancements in pump and motor control devices have made available the ability to automatically control membrane feed pressure to a high degree in contemporary system designs. A similar level of automatic control of concentrate and recirculation flows in any practical form has not been available in commercial scale membrane systems. The great majority of such systems rely on calibration of concentrate and recirculation flow rates using manual metering valves and rotometer flow indicators on a periodic basis. This common methodology for controlling concentrate and recirculation flow rates is problematic due to the basic nature of membrane separation systems which is that they are subject to continuous change of their hydraulic performance variables as they operate over time. Two characteristics of the feed fluid (its mineral content or salinity and its temperature) will require adjustment of the existing feed pressure and concentrate and recirculation flow rates if those characteristics change even a relatively small amount. Such changes, especially temperature which is affected by season, are not unusual. Another changing variable is the inherent performance of the membrane barrier element itself. Such elements have a specific life span and will degrade and reduce in output as they are used. Again, this change in performance can be compensated up to a point in a membrane system by adjustment of the three key variables. For example, because chemical characteristics (salinity, mineral, or other contents) in a water supply system can vary or change form user to user, from water source to water source, or from time to time, all of which impact pressures on a membrane separation system, an automated solution to adjusting flow is advantageous. Unfortunately, in too many instances, the frequency of adjustment and service given to operating commercial membrane systems is inadequate, thereby leading to systems that do not perform at the expected level or which fail entirely and require major service and repair.

This invention addresses the problems just described by allowing two of the three critical hydraulic parameters (i.e. concentrate flow and recirculation flow) within a membrane system to be continually and automatically kept in adjustment during operation. The overall result should be a significant improvement in membrane system reliability, product fluid quality and reduced maintenance requirements.

### SUMMARY OF THE INVENTION

The subject of this invention is an actuated valve mechanism that functions in combination with a programmable logic controller (PLC) and a plurality of flow rate sensors to adjust the flow rates through a valve portion of the mechanism in order to automatically maintain a desired specific flow rate which is optimum for the overall performance of the host water treatment system. Exemplary water treatment systems include mem The actuated valve mechanism includes a driving element, typically a stepper type motor or a servo type motor, a metering valve, typically of the needle or globe type, a gear train connecting the drive motor shaft and the valve shaft, the electronic circuit devices needed to adapt signals from the PLC into the motor drive command signal format, a position sensor or sensors to detect the physical limits of travel of the valve shaft, and a rigid mounting plate that mounts and maintains the motor, the gear train and elements of the metering valve in a fixed physical configuration while also allowing space for mounting of the necessary electronic components. One of the key characteristics of the motor, the gear train, and valve configuration in this mechanism is that the configuration allows for axial movement of the shaft of the valve as well as rotational movement. Almost all of the typical metering valve designs of the needle or globe type are characterized as rising stem type. This means that as the stem or the shaft of the valve is rotated to increase or decrease flow through the valve, the shaft of the valve will translate axially (i.e.: “vertically” in the attached figures) over some distance as it is rotated. This makes direct shaft connection to a driving source such as a motor or its linkage to the valve shaft require that the motor also be able to move in some fashion to accommodate this axial translation which can result in a complex mechanism and possible reduction in precision of valve positioning due to the necessary flexibility of the driving motor mounting or linkage. In the subject actuated valve mechanism, the drive element or motor is rigidly mounted, the valve is rigidly mounted, and the associated gear train connecting the shaft of the drive motor to the shaft of the valve is configured to allow the valve shaft idler gear to translate axially as it is driven by the drive motor spur gear by utilizing a motor shaft gear with a face distance greater than the possible axial travel of the idler gear. This affords a simpler and direct means of accommodating valve shaft axial translation in motor driven valve actuators while retaining a mechanically rigid transmission between the drive motor and the valve shafts.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A is a side elevation view of the present actuated valve mechanism according to an embodiment herein;

FIG. 1B is a front elevation view corresponding to FIG. 1A;

FIG. 1C is a top plan view corresponding to FIGS. 1A and 1B;

FIG. 1D is a sectional plan view taken along line 1D-1D in FIG. 1A; and

FIG. 2 diagrammatically illustrates the function of the actuated valve mechanism in a typical membrane separation system according to an embodiment herein.

### DETAILED DESCRIPTION OF THE PREFERRED EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Disclosed is a specific and a unique arrangement of one or more mechanical and electronic elements which, when connected, attached and configured as described hereinafter, function to provide membrane separation for a liquid in a manner which greatly improves the overall efficiency and stability of the membrane separation system.

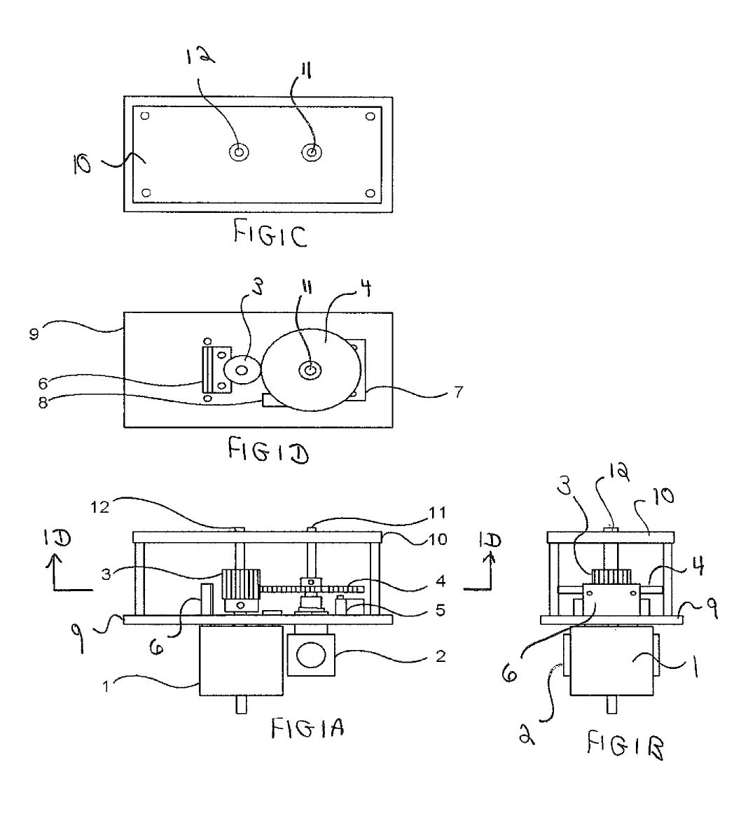

FIGS. 1A to 1D illustrate one or more mechanical and electronic components of an actuated valve mechanism according to an embodiment herein. A rigid mounting plate 9 holds the one or more mechanical and electronic components which serve to maintain the one or more mechanical components in precise dimensional relation to each other as well as rigidly mounting the one or more electronic components associated. A drive motor 1 is the drive element for a metering valve 2, preferably of the stepper or servo type. An output shaft of the drive motor 1 couples and secures a drive motor spur gear 3. The metering valve 2 is installed on a mounting plate 9 in near proximity to the drive motor 1. An adjustment shaft of the metering valve 2 couples and secures an idler spur gear 4. The mounting plate 9 holds both the drive motor 1 and the metering valve 2 so that when the drive motor spur gear 3 and the idler spur gear 4 are respectively installed on the shafts of the drive motor 1 and the metering valve 2, the pitch diameters of each gear intersect tangentially where the gears mesh. Further, the pitch diameter and gear tooth ratio between the drive motor spur gear 3 and the idler spur gear 4 are chosen to provide the drive gear with a mechanical advantage typically between 2:1 and 4:1 when driving the idler spur gear 4. Beside the mechanical advantage which lowers the torque required by the drive motor spur gear 3 to turn the idler spur gear 4, the gear ratio of 2:1 or higher increases the resolution of rotational movement of the idler spur gear 4 as a function of the gear ratio. For a given degree of rotation of the drive motor spur gear 3, the resulting fraction of a degree of rotation of the idler spur gear 4 becomes smaller in proportion to the gear ratio. The reduction allows achievement of finer adjustment of the position of the metering valve 2 which is controlled by rotation of the idler spur gear 4. The idler spur gear 4 rigidly couples the adjustment shaft of the metering valve 2. The adjustment shaft of the metering valve 2 translates vertically either in or out depending on the direction of rotation of the drive motor spur gear 3 when the rotation of the drive motor spur gear 3 drives the idler spur gear 4. During the translating motion of the idler spur gear 4, the teeth of the idler spur gear 4 correspondingly travel up or down the face of the drive motor spur gear 3 (i.e. idler spur gear 4 moves vertically up or down on the face of spur gear 3 in FIG. 1A). If the drive motor spur gear 3 rotates in a manner to cause the idler spur gear 4 to translate inward toward the body of the metering valve 2, the translation movement and the rotation of the shaft of the metering valve 2 mechanically stops when the shaft of the metering valve 2 reaches the fully closed valve position. If the drive motor spur gear 3 rotates in a manner to cause the idler spur gear 3 to translate outward away from the body of the metering valve 2 the translation movement and shaft rotation mechanically stops when the shaft of the metering valve 2 reaches the fully open valve position. The illustrated vertical translation distance that the idler spur gear 4 travels from fully closed to fully open valve positions is the maximum axial travel dimension. The face dimension of the drive motor spur gear 3 is large enough such that the drive motor spur gear 3 meets or exceeds the maximum vertical travel dimension of the idler spur gear 4 thereby allowing smooth engagement and relative motion of both the drive motor spur gear 3 and the idler spur gear 4 over the full span of valve adjustment travel. The one or more electronic components 6 and 8 of the valve mechanism, are discrete signal conditioning circuits that accept electronic pulse signals from the PLC, convert the signals and adapt the signals to a format compatible with the input signal requirement of the motor 1. The primary signals transmitted to the motor 1 include direction of rotation, rate of rotation and amount of rotation. A snap action switch 5 contains a set of electrical contacts which change from open state to closed state whenever the actuating lever of the snap action switch 5 is depressed past the actuation point. The contacts in the snap action switch 5 are connected electrically to an input port within the PLC and serve to signal the PLC when the metering valve 5 has been rotated inward and reached a functionally closed position. The snap action switch 5 and a mechanical mounting block 7 of the snap action switch 5 couples to the mounting plate 9 in a manner that places the actuating lever of the snap action switch 5 in contact with the underside of the idler spur gear 4 as the idler spur gear 4 rotates and approaches the fully closed inward travel valve position. The snap action switch 5 is mechanically adjusted so that the internal switch contacts of the snap action switch 5 actuate and change state when the idler spur gear 4 which is contacting and depressing the switch actuation lever is within a short turning distance of reaching the fully closed valve position typically 15 degrees of rotation before the valve reaches the fully closed mechanical stop position. This is considered the functional closed position, in which very little flow passes through the metering valve 2. In one embodiment, when rotation of the metering valve is stopped just short of full mechanical closure, the possibility of overloading both gear transmission and drive motor may be avoided which would occur if the mechanical closed or stop position were reached while drive motor and gear transmission were applying torque to the shaft of the metering valve 2. The PLC uses the signal information obtained from actuation of the snap action switch 5 at the functional valve closure point to establish a zero rotary position point beyond which the metering valve remains inoperative in all subsequent drive commands delivered to the drive motor 1. Further, based on the specification data of the metering valve 2 pertaining to the degrees of rotation between full closed and full open positions of the metering valve 2, the PLC establishes the maximum number of degrees of rotation it may drive the metering valve 2 towards the full open position before reaching the mechanically full open position. Again, the PLC stops short of the specified full mechanical open position by a short rotational distance, typically 15 degrees, to avoid driving the shaft of the metering valve 2 into the fully open mechanical stop position. In an alternate configuration, the actuated valve mechanism may possess an additional rigid bearing mounting plate or structure 10 which would be rigidly connected to the rigid mounting plate 9. The bearing mounting plate 10 includes a valve shaft outer bearing 11 and a drive shaft outer bearing 12, said bearings 11 and 12 being of the plain or roller type. Said bearings 11 and 12 would be mounted within the bearing mounting plate 10 such that extended drive motor 1 and valve shafts would enter the respective bearings with the shaft ends being the bearing journals. The function of the shaft bearings in this alternate configuration being to minimize axial defection of the motor and valve shafts during rotation and load transfer from the drive gear to the shaft gear.

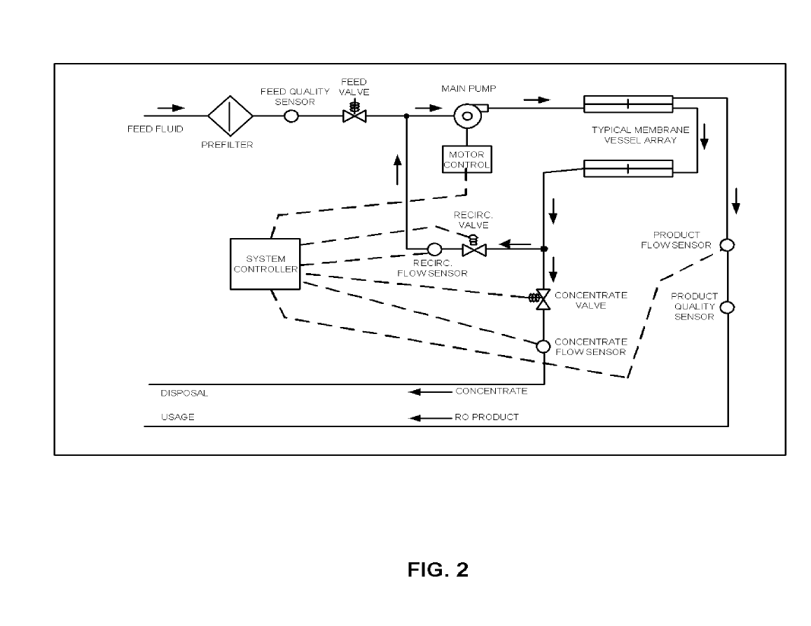

FIG. 2 illustrates a typical system embodiment of the actuated valve mechanism within a membrane fluid separation device. The diagram shows a typical membrane separation system. The typical membrane separation system includes a feed filtration or prefilter component, a feed fluid quality sensor, a feed fluid control valve, a main pump, a main pump motor control, an array of one or more membrane elements placed inside pressure vessels, a product fluid flow sensor, a product fluid quality sensor, a recirculation control valve, a recirculation flow sensor, a concentrate valve which controls the amount of concentrate allowed to leave the system, a concentrate flow sensor and system controller which may be of the PLC type. The main pump provides pressurized feed fluid to the membrane elements. The main pump motor control may be on/off control or variable pump speed control. The recirculation control valve allows diversion of a portion of the concentrate flow emanating from the membrane array to be introduced into the feed supply to the main pump. The primary variables of the typical membrane separation system include, feed fluid quality which generally relates to the amount and type of chemical, mineral or other solutes contained within the fluid, the temperature of the fluid, the fluid pressure applied to the feed inlet of the membrane array, the rate of flow of concentrate leaving the system as a fraction of the rate of flow of feed entering the system, and the rate of flow of concentrate fluid which is diverted to the inlet of the main system pump as recirculated fluid. Once the particular membrane element(s) are chosen with their specific operating characteristics the most influential operating parameters of the system are feed pressure to the membrane array, concentrate flow rate and recirculation flow rate. Establishing values for these parameters can be done by individual experience in membrane system design. Also, there exists design modeling software available from industry sources which, using specific membrane model data, feed fluid quality data and desired product fluid output rate among other data, calculates exact values for the principle pressure and flow parameters. In common practice, the parameter operating values are obtained by manual adjustment of the speed of the main pump motor for membrane feed pressure, concentrate valve for concentrate flow rate and recirculation valve for recirculation flow rate. Since these three parameters are hydraulically interrelated, adjustment of one causes the other two to change somewhat necessitating a back and forth manual adjustment process until all three reach their desired values within an acceptable tolerance. In an embodiment presented here, the system controller operates the actuated valve mechanisms shown as concentrate valve and recirculation valve in FIG. 2 to achieve the same optimum pressure and flow parameter values in a rapid and automated process. The system controller memory is provided with the desired values for fluid product flow rate, concentrate flow rate and recirculation flow rate as derived by experience or design software. In operation, the system controller receives one or more electronic signals from flow sensor devices representing product, concentrate and recirculation fluid flow rates. The system controller then transmits commands to the main pump motor control, the concentrate actuated valve mechanism and the recirculation actuated valve mechanism in a coordinated manner so that the desired product, concentrate and recirculation flow rates are achieved and maintained by reference to the respective flow sensor devices. This process of adjustment of the three interdependent hydraulic variables is completed in a time span and at a level of precision not possible by the typical manual process. More importantly, the adjustment control exercised by the system controller is continuous and automatic as long as the membrane system is operating. The importance of the continuous nature of control made possible in this embodiment lies in the nature of typical membrane systems which is that they are subject to peripheral environmental and inherent variations that require regular adjustment of the system hydraulic parameters if optimum performance is to be maintained. Feed fluid temperature, feed fluid solute type and content and standard aging and degradation of the membranes elements are just three factors that are generally not constant over extended membrane system operating periods and that, if not compensated for by regular manual key parameter adjustment, will result in membrane system performance reduction or failure. Incorporation of the subject actuated valve mechanisms in a system embodiment as illustrated in FIG. 2 and as just described creates a new and unique control system with definite value and advantages over typical current membrane system designs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A motorized metering valve actuation mechanism, comprising:
a rigid mounting plate;
a drive motor mounted to the mounting plate, the drive motor having:
a drive shaft, and
a drive motor spur gear mounted to the drive shaft; and
a metering valve mounted to the mounting plate, the metering valve having:
a drive shaft, and
an idler spur gear mounted to the drive shaft,
wherein the drive motor spur gear is in contact with the idler spur gear, and
wherein the idler spur gear moves up and down along the face of the drive motor spur gear as the metering valve is opened or closed.

2. The mechanism of claim 1, wherein the drive shaft of the drive motor is parallel to the drive shaft of the metering valve.

3. The mechanism of claim 1, wherein the drive shaft of the drive motor and the drive shaft of the metering valve extend a similar distance above the surface of the rigid mounting plate.

4. The mechanism of claim 2, wherein the distance between the centers of the drive shaft of the drive motor and the drive shaft of the metering valve equals the pitch diameter of the drive motor spur gear and the pitch diameter of the idler spur gear, and wherein a center-to-center distance between the drive shaft of the drive motor and the drive shaft of the metering valve makes the pitch diameters of the drive motor spur gear and the idler spur gear intersect where the drive motor spur gear and the idler spur gear mesh.

5. The mechanism of claim 1, wherein the drive motor spur gear and the idler spur gear have the same pitch and pitch angle at respective pitch diameter tangents.

6. The mechanism of claim 1, wherein the face dimension of the drive motor spur gear is larger than the face dimension of the idler spur gear by a factor that allows the idler spur gear to traverse the face of the said drive motor spur gear over the maximum range of the rising or falling metering valve shaft translation without the idler spur gear disengaging from the drive motor spur gear, when the gears are rotated to the extent necessary to move the valve shaft axially from valve full open to valve full closed positions.

7. The mechanism of claim 1, wherein pitch diameters and numbers of teeth for the drive motor spur gear and the idler spur gear are selected so that the transmission ratio between the drive motor spur gear and the idler spur gear is typically on the order of 2:1 to 4:1.

8. The mechanism of claim 1, further comprising:
an electric snap action switch located underneath the drive motor spur gear that is actuated when the idler spur gear traverses downward to the closed or almost closed valve position.

9. The mechanism of claim 8, wherein the electric snap action switch is capable of a degree of positional adjustment allowing a precise distance between the bottom surface of the valve shaft spur gear and the surface of the rigid plate to be established by calibration.

10. The mechanism of claim 1, further comprising:
electronic drive and signal conditioner elements mounted on the rigid mounting plate in close proximity to the components of the drive motor and the metering valve, the electronic drive and signal conditioner elements providing the specific driving signal format required by the drive motor based upon command signals received by the electronic drive from a remotely located control system.

11. The mechanism of claim 10, wherein the remotely located control system is a programmable logic controller.

12. The mechanism of claim 11, wherein the programmable logic controller controls the flow of liquids in a hydraulic process system so that a specific desired flow rate is maintained.

13. The mechanism of claim 11, wherein the programmable logic controller controls the flow of liquids in a membrane separation system so that a specific desired flow rate is maintained.

14. The mechanism of claim 11, wherein the programmable logic controller controls the fluid feed pressure applied to a membrane or membrane array by means of controlling the output of a pump supplying the pressure while simultaneously controlling the concentrate flow rate so that a preset product flow rate is maintained while also maintaining the preset concentrate flow value within a preset tolerance range.

15. The mechanism of claim 11, wherein the programmable logic controller controls the fluid feed pressure applied to a membrane or membrane array by means of controlling the output of a pump supplying the pressure while simultaneously controlling the concentrate flow rate and the recirculation flow rate so that a preset product flow rate is maintained while also maintaining preset concentrate and recirculation values within a preset tolerance range.

16. The mechanism of claim 11, wherein the programmable logic controller controls the fluid feed pressure applied to a membrane or membrane array by means of controlling the output of the pump supplying the pressure while simultaneously controlling the concentrate flow rate so that a preset desired concentrate flow rate is maintained within a preset tolerance range.

17. The mechanism of claim 1, further comprising:
a rigid bearing mounting plate attached to the rigid plate base, the bearing plate mounting two shaft bearings positioned such that an extended length drive motor and the valve shafts enter and are held within the respective bearings.
